(19) United States
(12) Patent Application Publication
(10) Pub. No.: US 2020/0164391 A1
(43) Pub. Date: May 28, 2020

(54) ELECTROSTATIC ATOMIZER FOR ELECTROSTATICALLY COATED WORKPIECES

(71) Applicant: EISENMANN SE, Böblingen (DE)

(72) Inventors: Jan Reichler, Konstanz (DE); Jannis Tomaschko, Holzgerlingen (DE)

(21) Appl. No.: 16/622,339

(22) PCT Filed: May 8, 2018
(86) PCT No.: PCT/EP2018/061764

§ 371 Date: Dec. 13, 2019

(30) Foreign Application Priority Data
Jun. 14, 2017 (DE) 10 2017 113 180.9

(51) Int. Cl. B05B 5/043; B05B 5/053; B05B 5/08

(52) U.S. Cl. CPC B05B 5/043; B05B 16/00; B05B 5/08; B05B 5/0533

(57) ABSTRACT

An electrostatic atomizer for electrostatically coating a workpiece, in particular for coating vehicle bodies or parts thereof, with a coating material, having both an inner electrode and an outer electrode for electrostatically charging the coating material.

### BACKGROUND OF THE INVENTION

### 1. Field of the Invention

The invention relates to an electrostatic atomizer for the electrostatic coating of workpieces, in particular for the coating of vehicle bodies or parts thereof, with a coating material.

### 2. Description of Prior Art

It is known to use electrostatic atomizers for the coating of workpieces, wherein the electrostatic atomizers atomize and electrically charge a coating material, in particular paints such as wet paint or coating powder. As a result, the atomized paint droplets or paint particles are ionized and accelerated to the workpiece with the aid of an electric field generated between the electrostatic atomizer and the workpiece, which increases the application efficiency during coating.

Three main charging mechanisms are thereby known for electrostatic charging.

This is, on the one hand, a triboelectric charge in which the atomized particles rub along a material that is not conductive in itself and are thereby electrostatically charged—similar to the charging of a balloon with the aid of animal furs.

Furthermore, the so-called internal charging is known, in which the coating material is charged directly before atomization in the interior of the atomizer via an internal electrode.

Finally, the so-called external charge is known, in which the coating material is charged after atomization via at least one external electrode, which is located near or in the spray cone of the atomizer.

The individual charging mechanisms have different advantages and disadvantages. Therefore, different charging mechanisms are often used for different painting procedures within a total coating process.

In partially or fully automated coating systems, therefore, often either several successive painting booths are provided, in which painting robots with different atomizers are arranged, or several painting robots are arranged in one painting booth. In addition, a painting robot can also receive different electrostatic atomizers as tools in order to obtain the desired painting result. However, this requires corresponding changeover times during the total coating process.

### SUMMARY OF THE INVENTION

It is therefore the object of the invention to improve a known electrostatic atomizer with regard to the charging mechanism, in particular in order to achieve different effects during charging, without accepting the previous disadvantages of increased space requirements or changeover times.

According to the invention, this is achieved by an electrostatic atomizer of the type mentioned at the beginning, in which the electrostatic atomizer for the electrostatic charging of the coating material comprises both an internal electrode and an external electrode.

The inventors have recognized that despite the increased cabling effort, which is difficult to configure due to the high voltages used in the range up to approximately 150 kV, it can be useful to provide both an internal electrode and an external electrode for charging in order to provide an electrostatic atomizer for a combined internal and external charging. This is because such an electrostatic atomizer with an internal and an external electrode allows switching between the different charging mechanisms at the atomizer itself. This eliminates known disadvantages such as an increased space requirement or changeover times for changing tools on painting rotors.

In addition, there are further advantages due to the combined internal and external charging. For example, it can be advantageous to apply the same high voltage to the internal electrode and the external electrode via a common electrical supply line. This is because a higher throughput of the charged coating material can thereby be achieved.

Preferably, however, the internal electrode and the external electrode can each be actuated separately via their own electrical supply line, which allows further diverse actuating schemes to be performed and, above all, allows the switching between different charging mechanisms to be implemented.

The electrostatic atomizer can preferably comprise a plurality of external electrodes, which can each be actuated via their own electrical supply line. Usually, for external charging, a ring of outwardly directed external electrodes is provided at the front head end of the atomizer, the external electrodes surrounding the front part of the atomizer. The external electrodes thereby protrude into or near the spray cone. Different areas of the spray cone can be charged differently by means of their own electrical supply lines.

Preferably, the external electrode can be configured to be brought into at least two different positions with respect to the front end of the atomizer. In particular, the external electrode can comprise a mechanism by means of which the external electrode can be set against the atomizer head or spread away from the atomizer head. This allows the external dimensions of the atomizer to be reduced when, for example, external charging is switched off. This can be advantageous, for example, when painting the interior of a vehicle body.

The position change of the external electrode can be initiated by actuators on the atomizer, such as compressed air actuators. However, it is also conceivable that the external electrode has two locking positions and that corresponding actuating forces act on the external electrode from the outside, e.g. by the painting robot moving the atomizer with the external electrode along a stop.

Preferably, an electrostatic coating system with the electrostatic atomizer according to the invention can be provided. The electrostatic coating system can thereby comprise at least one high voltage source connected to the internal electrode, to the external electrode or to both, and a control unit configured to control the at least one high voltage source.

In this way, the control unit can control different charging constellations.

Preferably, the electrostatic coating system can comprise two high voltage sources, wherein one of the two high voltage sources is connected to the internal electrode and the other of the two high voltage sources is connected to the external electrode.

This allows a larger amount of charge amount per time to be transferred to the coating material by switching on both high voltage sources.

Preferably, the control unit can be configured to apply high voltage of the same or different magnitude to the internal electrode and the external electrode.

In particular, this can also comprise a complete switching off of the high voltage at the internal electrode or at the external electrode.

The control unit can also be configured to switch off and switch on the high voltage at the internal electrode and the external electrode simultaneously or non-simultaneously.

Preferably, the control unit can be configured to change the respective high voltage of one or both high voltage sources continuously or quasi-continuously, in the case of two high voltage sources in particular in opposite directions, from one end value to another end value.

In this way, it is possible to switch more smoothly from one charging mechanism to another, which makes it easier to perform transitions between painting procedures.

Preferably, in the case of a plurality of external electrodes with their own electrical supply lines, the control unit can be configured to control the plurality of external electrodes separately. This allows, for example, an asymmetrical external charge to be generated, which in turn generates an asymmetrical spray cone. The effect of the spray pattern change can thereby be enhanced by a corresponding individual regulation of the high voltage at the individual electrodes. This is because the higher the high voltage applied to an external electrode, the more the spray cone spreads in the sectional plane in which the external electrode is located with respect to a central axis.

For this purpose, the associated high voltage source can be equipped with a plurality of switchable outputs which are actuated by the control unit. However, it is also conceivable that the control unit for the individual supply lines actuated their own high voltage sources in each case. In addition, individual external electrodes can also be combined to form groups, each of which can be applied with a common high voltage via a supply line.

Preferably, the control unit can be configured such that a basic charge is first generated via the internal electrode and the spray pattern is changed by switching individual external electrodes on or off.

According to another aspect of the invention, an electrostatic atomizer according to the invention and/or an electrostatic coating system according to the invention can be used for the painting of vehicle bodies or parts thereof. This increases the efficiency of the total coating process compared to the previously known Prior Art.

### BRIEF DESCRIPTION OF THE DRAWINGS

In the following, embodiments of the invention are explained in more detail based on the drawings.

FIG. 1 shows an electrostatic atomizer according to the invention with an internal electrode and a ring of external electrodes with two separate high voltage sources;

FIG. 2 shows an electrostatic atomizer according to the invention with an internal electrode and a ring of external electrodes which can be actuated separately;

FIG. 3 shows an electrostatic atomizer according to the invention with an internal electrode and a ring of external electrodes which can be actuated separately and can be folded to the atomizer head;

FIG. 4 shows an electrostatic atomizer according to the invention with an internal electrode and a ring of external electrodes with a common high voltage source.

### DESCRIPTION OF PREFERRED EMBODIMENTS

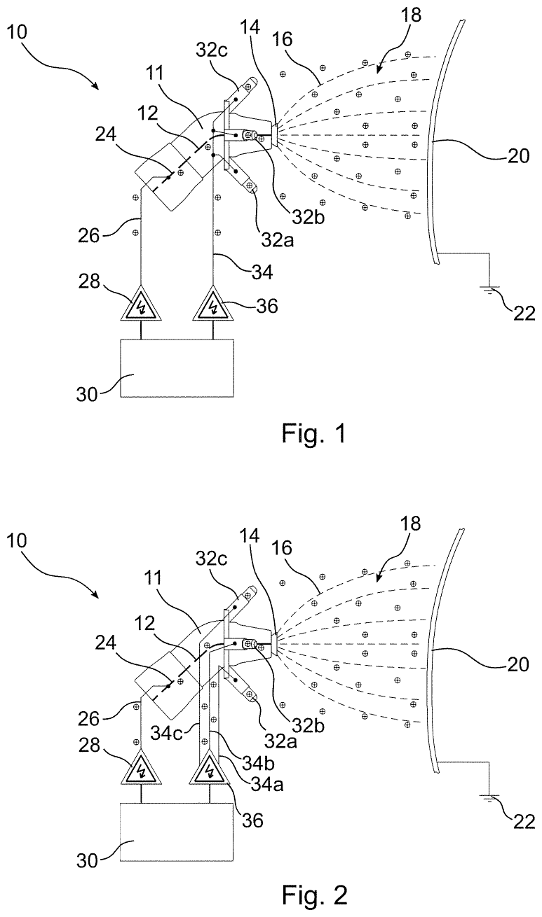

FIG. 1 shows an electrostatic coating systems, denoted overall by 10, with an electrostatic atomizer 11, here in the form of a rotary atomizer.

The electrostatic atomizer 11 has a paint line 12 via which a paint 16 can be fed as coating material to a rotary bell plate 14 at the front distal end of the electrostatic atomizer 11. The electrostatic atomizer 11 then generates an initially rotationally symmetrical spray cone 18 of atomized paint 16, which is directed onto a workpiece 20.

As symbolically indicated in the figures, the workpiece 20 for electrostatic coating is electrically connected to earth potential 22 via a support device not shown here, such as a skid for conveying vehicle bodies.

In contrast, the electrostatic atomizer 11 has an electrically conductive area as an internal electrode 24 in the paint line 12 for the internal charging of the paint 16 before atomizing the coating material.

This internal electrode 24 is connected via an electrical supply line 26 to a first high voltage source 28, which in turn is actuated by a control unit 30.

Furthermore, in addition to the internal electrode 24, the electrostatic atomizer 11 has at its front end a ring of a plurality of external electrodes 32a, 32b and 32c, only three of which are shown in the drawing. However, the exact number of external electrodes 32a, 32b and 32c generally depends on the configuration of the atomizer 11. The external electrodes 32a, 32b and 32c are each connected to a second high voltage source 36 via an electrical supply line 34. The second high voltage source 36 is also actuated by the control unit 30.

The electrostatic coating system 10 according to FIG. 1 functions as follows:

Depending on the desired charging mechanism for an upcoming painting procedure of a total coating process, the control unit 30 controls either the first high voltage source 28 or the second high voltage source 36 or both in order to apply high voltage to the internal electrode 24 or the external electrodes 32a, 32b, 32c with respect to the workpiece 20 and to thereby achieve an electrostatic charge of the paint 16.

For example, to paint the inside of a vehicle body, the control unit 30 can only activate the interior charging via the first high voltage source 28 and for the painting procedure on the outside of the vehicle body can only activate the external charging via the second high voltage source 36.

In addition, however, the control unit 30 is also configured, for example, to activate a basic charge via the first high voltage source 28 by specifying a high voltage value there. The external charging can then be activated additionally via the second high voltage source 36.

The control unit 30 can also be configured to switch continuously from internal charging via the first high voltage source 28 to external charging via the second high voltage source 36 by gradually reducing the charge via the internal electrode 24 while gradually increasing the charge via the external electrodes 32a, 32b and 32c. The control unit 30 can also generate a corresponding transition in the reverse direction. In this way, various transitions between internal charging and external charging of the coating material are conceivable and possible with the electrostatic atomizer 11.

FIG. 2 shows an electrostatic coating system 10 which differs from the embodiment according to FIG. 1 in that the individual external electrodes 32a, 32b and 32c of the atomizer 11 are provided in each case with their own electrical supply lines 34a, 34b and 34c which are connected to the second high voltage source 36. The second high voltage source 36 and the control unit 30 are thereby configured such that high voltage can be applied to the individual external electrodes 32a, 32b and 32c separate from one another.

In this way, the control unit 30 can actuate certain of the external electrodes 32a, 32b or 32c by correspondingly actuating the second high voltage source 36 in order to generate an external charge that produces an asymmetric shape for the spray cone 18.

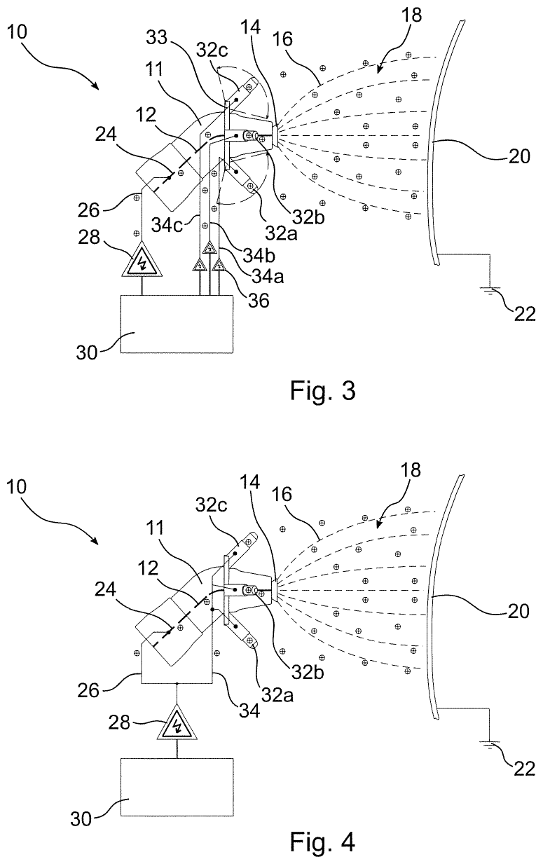

FIG. 3 shows an electrostatic coating system 10, which differs from the embodiment according to FIG. 2 in that the individual external electrodes 32a, 32b and 32c of the atomizer 11 are each connected to the front end of the atomizer 11 via a locking joint 33.

As indicated by the arc-shaped arrows, this allows the external electrodes 32a, 32b and 32c to be brought into different positions. For example, the external electrodes 32a, 32b and 32c can be folded towards the front end of the atomizer 11 or spread away from the front end of the atomizer 11 by means of actuators not shown or by external actuation. This makes it possible, for example, to switch off the high voltage at the external electrodes 32a, 32b and 32c for painting the interior of a vehicle body and to reduce the external dimensions of the atomizer 11 by folding the external electrodes 32a, 32b and 32c.

Independent of the foldable external electrodes 32a, 32b and 32c, the embodiment shown in FIG. 3 also differs in the configuration of the high voltage source 36 for the external electrodes 32a, 32b and 32c and their actuation via the control unit 30.

Regarding FIG. 2, it is conceivable that the high voltage source 36 there has a type of multiplex switch at the output which switches the respective outputs for the electrical supply lines 34a, 34b and 34c on or off in order to activate different external electrodes 32a, 32b and 32c. This multiplex switch can then be actuated via the control line between the control unit 30 and the high voltage source 36.

In contrast, FIG. 3 shows a variation with a plurality of high voltage sources 36 for the respective supply lines 34a, 34b and 34c. This makes it possible to apply high voltages of different magnitudes to the individual external electrodes 34a, 34b and 34c.

Of course, the two concepts can also be combined. In addition, individual external electrodes 34a, 34b and 34c can also be combined in groups, each supplied via a common supply line 34a, 34b and 34c.

FIG. 4 shows an electrostatic coating system 10 which differs from the previous embodiments in that for the internal electrode 24 and for the ring of external electrodes 32a, 32b and 32c only a common first high voltage source 28 is provided by the two electrical supply lines 26 and 34, preferably inside the atomizer head, being connected to each other. This means that the internal charging and the external charging can only be switched on and off together.

A further variation of the invention, not shown here, comprises an atomizer which, in addition to the paint line 12 described above, also comprises a further paint line which is optionally equipped with or without an internal electrode. In this way, different types of paint can be used even more easily with both internal and external charging.

What is claimed is:

1. An electrostatic atomizer for the electrostatic coating of workpieces with a coating material, comprising: an internal electrode and an external electrode for electrostatic charging of a coating material.

2. The electrostatic atomizer according to claim 1, wherein the internal electrode and the external electrode can each be actuated separately via their own electrical supply line.

3. The electrostatic atomizer according to claim 1, further comprising a plurality of external electrodes which can each be actuated via their own electrical supply line.

4. The electrostatic atomizer according to claim 1, wherein the external electrode is configured to be brought into at least two different positions with respect to a front end of the electrostatic atomizer.

5. An electrostatic coating system comprising
an electrostatic atomizer according to claim 1;
at least one high voltage source connected to the internal electrode, to the external electrode or to both the internal electrode and the external electrode, of the electrostatic atomizer; and
a control unit configured to control the at least one high voltage source.

6. The electrostatic coating system according to claim 5, wherein the at least one high voltage source comprises two high voltage sources, wherein one of the two high voltage sources is connected to the internal electrode of the electrostatic atomizer, and the other of the two high voltage sources is connected to the external electrode of the electrostatic atomizer.

7. The electrostatic coating system according to claim 5, wherein the control unit is configured to apply high voltage of a same or different magnitude to the internal electrode and the external electrode.

8. The electrostatic coating system according to claim 6, wherein the control unit is configured to change a respective high voltage of one or both high voltage sources quasi-continuously in opposite directions, from one end value to another end value.

9. The electrostatic coating system according to claim 5, wherein the electrostatic atomizer comprises a plurality of external electrodes, and the control unit is configured to separately control the plurality of external electrodes.

10. A method of painting vehicle bodies comprising the step of using an electrostatic atomizer as claimed in claim 1.

11. The electrostatic coating system according to claim 5, wherein the control unit is configured to change a high voltage of the at least one voltage source quasi-continuously.

12. A method of painting vehicle bodies comprising the step of using an electrostatic coating system as claimed in claim 5.
